(19) United States
(12) Patent Application Publication
(10) Pub. No.: US 2006/0112303 A1
(43) Pub. Date: May 25, 2006

(54) Local backup device with remote management capability and method for remote backup management

(75) Inventor: Itzhak Levy, Hollywood, FL (US)

Correspondence Address: LERNER GREENBERG STEMER LLP, P O BOX 2480, HOLLYWOOD, FL, 33022-2480, US

(73) Assignee: Arco Computer Products, LLC.

(21) Appl. No.: 10/984,602

(22) Filed: Nov. 9, 2004

(51) Int. Cl. G06F 11/00

(52) U.S. Cl. 714/6

(57) ABSTRACT

Local backup operations in a computer are organized from a remote computer. The local computer has an intermediate device controller and at least one additional hard disk drive for backup. There are two types of backup operations provided. The first is an image backup which assures that the backup hard disk drive will be an exact duplicate of the system disk drive, thus contain all data, programs and system information, and in fact it becomes a bootable disk. In this way, the backup disk can completely replace the failed system disk. The second type is a file backup, which may include all files, selected files, or only files modified since the last backup. No user involvement is needed when the backup is taking place. All commands necessary to the backup operation, whether it will be an image backup or a file backup, can be sent remotely, through network and/or Internet connections. This has the advantage of providing remote administration together with tracking and monitoring information. If so configured, it can remove this responsibility from the local user, while combining the convenience and economy of providing backup to a local disk. The intermediate device and the backup operation is entirely transparent and invisible to the local computer operating system.

### BACKGROUND OF THE INVENTION

1. Field of the Invention

The invention lies in the computer backup technology field. More specifically, the invention relates to an intermediate device controller for a computer system.

The term “computer system” as used herein should be understood in a very wide sense of the term. While the most common use of the invention will likely be with desktop computers, servers, or near line storage systems, the device according to the invention works with a multitude of other specialized devices such as point-of-sale terminals, telephony, computer numerical controllers, medical testing and monitoring equipment, and other similar client devices. The invention should be understood to broadly apply to all such systems and devices.

2. Description of the Related Art

As the use of computer systems has greatly increased and the amount of complexity has grown, the amount of data storage required has increased enormously. Data stored on a computer system is generally extremely valuable because it is the result of a great deal of time and effort. If such data is lost, much time and effort would need to be duplicated to reconstruct it. In some cases, reconstructing the data is not possible. Additionally computer viruses or operator errors can corrupt data in a manner that might not be noticed for several days. For these reasons, it is desirable to systematically store data with more than one copy, and in more than one location.

Data should be stored automatically and in multiple locations to assure that data is backed up without relying on an operator who might intentionally or inadvertently fail to backup manually.

If data is lost, it is important that it be restored quickly to minimize the loss of time and money.

The most common method of long-term storage of programs and data on computer systems is the hard disk drive. A hard disk drive is an electromechanical device consisting of one or more rotating platters or disks, a movable electromagnetic transducer, and electronics to convey the information between the central processor and the disks.

The hard disk drive, while designed to be very reliable, is prone to failure because of the high speed mechanical operations that it is required to perform. Since failure of the hard disk drive may destroy all the programs and data that it contains, recovery to normal operation is often difficult or impossible if the programs and data cannot be restored from another source. For this reason, a number of different means to copy or “back up” hard disk programs and data have been developed.

Programs and data can be transferred (backed up) to another medium such as floppy disks, magnetic tape, CDROMs, USB flash devices, USB or FireWire Disk Drives, or other high density removable media. Some of these devices and methods, however, are slow, require significant operator intervention, and require the dedication of the central processor bandwidth for the duration of the transfer. Floppy disks and CDs contain a very small amount of data by today's standards. Any operation that involves transferring data to a number of storage devices is prone to error by the computer operator. Additionally the reliability of floppy disks and other removable media disks, magnetic tape, and CDROMs is low.

Programs and data can be transferred over a local computer network or the Internet and stored on another computer system disk, utilizing Disk to Disk (D2D) or tape backup. This has several disadvantages, namely:
usually only data is backed up;
most restores fail due to the lack of compatibility between the backed up data and the target restored system;
significant resources are required from the central processor;
special programs are required to accomplish the transfer;
significant time is required to backup since it is generally proportional to the amount of data;
significant time is required to restore the lost data;
the failed computer system cannot be immediately started (bootstrapped) without rebuilding the operating system;
sending critical data over the Internet will always increase the danger of a security risk, due to the public nature of Internet access; and
backup via network or Internet utilizes significant bandwidth.

The quality of any backup operation will depend on the regular and timely activation of the backup procedure. This may not always be followed by the individual users, who would much prefer backup administration by a specialized organization or other responsible party.

### SUMMARY OF THE INVENTION

It is accordingly an object of the invention to provide a computer backup system and a remote backup management method which overcomes the above-mentioned disadvantages of the heretofore-known devices and methods of this general type.

With the foregoing and other objects in view there is provided, in accordance with the invention, a computer system, comprising:
a host computer generating data output;
an intermediate device connected to receive the data output from the processor and configured to transfer the data to a plurality of channels; and
a plurality of data storage devices each connected to the hard disk drive controller for transferring data to or from a respective channel;
wherein a transfer of data between the data storage devices and through the intermediate device is effected substantially while the host computer remains enabled to transfer the data to and from at least one of the data storage devices.

In accordance with an added feature of the invention, the host computer is configured to receive remote commands via a network and send appropriate commands to the intermediate via the data cable or via a dedicated control port, local to the host computer.

Preferably, the intermediate device is configured to perform a background image disk copy or file backup as requested by the remote command or set by schedule. Similarly, the system is configured to perform a background image or file restore from one of the data storage devices as selected by a user of the host computer.

In accordance with another feature of the invention, the intermediate device is configured to receive a backup schedule for effecting an automatic backup even if a connection between the remote computer and the host computer is lost.

In accordance with a further feature of the invention, the intermediate device is configured to collect diagnostic data and to send the diagnostic data to the remote computer upon request.

With the above and other objects in view there is also provided, in accordance with the invention, a remote management method for local data backup, the method which comprises:
providing a local host computer having a main data storage device and a backup data storage device;
connecting the local host computer to a network and instructing the local host computer, substantially without involvement of an operator at the local host computer, to copy data from the main data storage device to the backup storage device or from the backup storage device to the main data storage device.

With the above and other objects in view there is also provided, in accordance with the invention, a method of managing local computer backup operations in a system in which a local host computer with a main data storage device and a backup data storage device is connected to a remote computer via a network, the method which comprises:
under control of the remote computer:
   issuing a maintenance command according to a predetermined schedule and transmitting the maintenance command through the network to the local host computer;
under control of the local host computer:
   receiving and processing the maintenance command with the local host computer;
   automatically performing a commanded maintenance operation by transferring data between the main data storage device and the backup data storage device substantially without involvement of a user of the local host computer and substantially without taking control of an operating system of the local computer away from the user of the local host computer; and
   preparing the local host computer for further maintenance commands to be received from the remote computer.

The present invention in its simplest form involves the use of an intermediate device controller and the addition of at least one additional hard disk drive known as the “backup hard disk drive”. There are two types of backup operations provided. The first is an image backup which assures that the backup hard disk drive will be an exact duplicate of the system disk drive, thus contain all data, programs and system information, and in fact will be a bootable disk. In this way, the backup disk can completely substitute the failed system disk. The second type is a file backup, which may include all files, selected files, or only files modified since the last backup. A unique feature of the present invention is that no user involvement is needed when the backup is taking place. All commands necessary to the backup operation, whether it will be an image backup or a file backup, can be sent remotely, through network and/or Internet connections. This has the advantage of providing remote administration together with tracking and monitoring information. If so configured, it can remove this responsibility from the local user, while combining the convenience and economy of providing backup to a local disk.

The remote management can be performed via the Internet or private network to the user's computer and via the user's computer the control to the invention can be done via the data port or the dedicated control port.

The present invention, in a more advanced form, may also have its own scheduling capability, after receiving initial programming via remote commands. In this way, backups and status logging can be performed locally at pre-determined dates and times, even if communication is severed.

The invention is a combination of hardware implementation and software to permit a remote command interface. Another unique feature of the invention is that it is inserted directly between the data connector from the computer and the data connectors on the system hard disk drives. In the case of image backup, after receiving local or remote commands, the computer and its operating system have no cognizance of the invention. Thus the invention is completely transparent to the type of computer or its operating system. The invention is designed to communicate with the computer and the hard disk drives via commonly used or future hard disk drive interface schemes.

With the foregoing and other objects in view there is provided, in accordance with the invention, a host computer system, comprising a processor generating data output, a disk controller designed to function as an intermediate device controller connected to receive the data output from the processor and configured to send the data output to one or more channels, and a plurality of data storage devices each connected to the intermediate device and each receiving the data output of a respective channel. Additionally the interface device allows data to be transferred from one hard disk drive channel to another and from any hard disk drive channel to the processor, with one or more hard drives attached to each channel.

The invention has several advantages. By way of example, inter alia, the invention:
helps prevent the loss of data and lost time when a hard disk drive failure occurs;
enables fast computer recovery in case of computer viruses or operator errors that destroy the current data on the hard disk drive,
allows local or remote backup control and administration of the backup, restore and monitoring operations
provides for a hard disk drive controller designed to function as an intermediate device, thereby eliminating the need to use other central processor resources such as expansion card slots, interrupts, input/output space, and address space,
provides an intermediate device designed to function without requiring device drivers or any support by the operating system itself;
provides the ability to remove the hard disk drives so that they can be taken off-site or stored in a secure location; and
allows a local backup in which data does not leave the user's local computer system.

Other features which are considered as characteristic for the invention are set forth in the appended claims.

Although the invention is illustrated and described herein as embodied in a backup method and system for remote backup management, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawing.

### BRIEF DESCRIPTION OF THE DRAWINGS

FIG. 1 is a block diagram of a conventional computer system in a network setting;

FIG. 2 is a block diagram of a computer system incorporating the novel interface according to the invention;

FIG. 3 is a block diagram showing the main hardware components of the novel interface according to the invention; and

FIG. 4 a flow chart of the software component of the novel interface, outlining an implementation of the invention.

### DESCRIPTION OF THE PREFERRED EMBODIMENTS

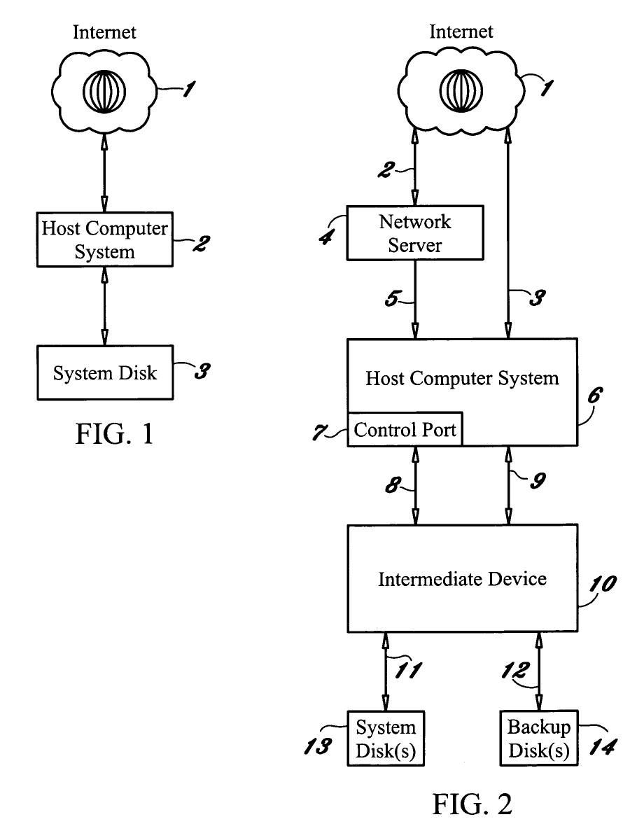

Referring now to the figures of the drawing in detail and first, particularly, to FIG. 1 thereof, there is shown a block diagram of a conventional computer system in a network setting. The network is represented by the Internet and/or a local network connection 1, and the local system includes a host computer system 2 and a system disk 3.

Referring now to FIG. 2 in detail, there is shown a block diagram illustrating, by way of example, a hard disk drive 13 (representing one or more drives) for a personal computer system or a small network server 6. The Host Computer 6 communicates with an intermediate device 10, through interface 9. It should be understood that the disk drive 13 represents any data storage device utilizing any present or future data storage device communications scheme, with or without a removable option.

During normal operation, the host computer 6 communicates with the System Disk(s) 13 through the interface or intermediate device 10 in a completely transparent manner. The intermediate device 10 constitutes a central part of the implementation of the invention.

When the host computer 6 receives a remote command from the network device 4 or via the Internet connection 3, the host computer 6 will send the appropriate command to the intermediate device 10 via the hard drive interface cable 9 or via a dedicated control port 8. When the intermediate device 10 receives a “backup” command, the intermediate device 10 will move the data from the system disk(s) 13 to the backup disk(s) 14. While data is moving between the system disk(s) 13 and the backup disk(s) 14, the host computer 6 will have the priority to access data on the system disk(s) 13. When the device 10 receives a restore command then data will be moved from the backup disk(s) 14 to the system disk(s) 13. The intermediate device 10 will support many other commands such as diagnostic, scheduling, and so on. It is clear that there is no upper limit to the command list that the novel intermediate device 10 may be configured to support.

If the remote command is for file backup, the intermediate device 10 makes the backup disk(s) 14 available to the operating system on the host computer 6. Software running on the host computer 6 will then cause selected files present on the system disk(s) 13 to be copied to the backup disk(s) 14. As soon as this operation is completed, the Intermediate Device 10 then causes the backup disk(s) 14 to again become unavailable for any reads or writes, until new local or remote commands are issued.

To restore data to the system disk(s) 13, another remote command can be issued which will cause the intermediate device 10 to transfer data from the backup disk(s) 14 to the system disk(s) 13.

In an alternative form, the intermediate device 10, may backup and restore files between the backup disk(s) 14 and the system disk(s) 13 directly, without utilizing any of the resources of the host computer 6.

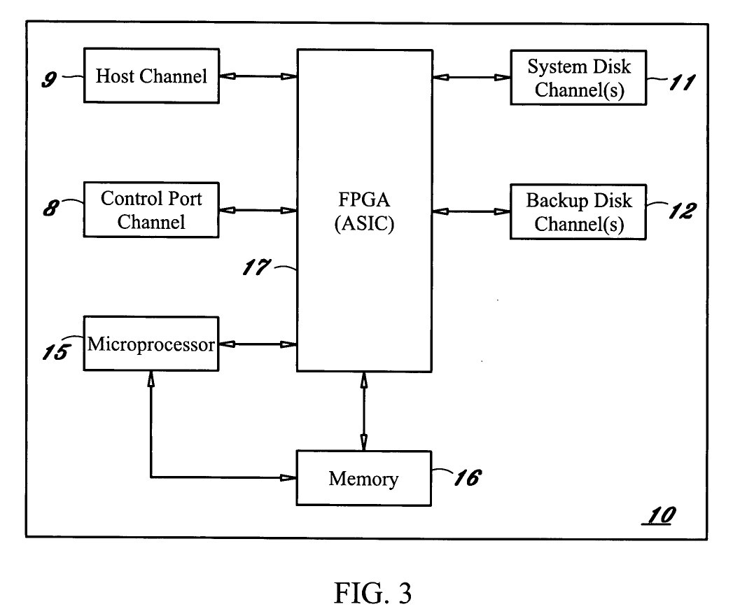

Referring now to FIG. 3, the hardware components of the intermediate device 10, in a typical configuration, include a host channel connector 9 and an optional control port 8 through which commands and data are sent to and received from the host computer system. The commands are interpreted by a microprocessor 15 following program instructions and data previously stored in a memory 16. This results in a control signal being sent to an FPGA (field programmable gate array) 17, which in turn controls flow of data from the host channel 9 to both the system disk channel(s) 11 and backup disk channel(s) 12. For example, the remote command to perform an image backup will cause the FPGA 17 to direct data from the most channel 9 to both the system disk channel(s) 11 and the backup disk channel(s) 12. It will also copy data from the system disk channel(s) 11 to the backup disk channel(s) 12, thus forming a complete, updated image backup.

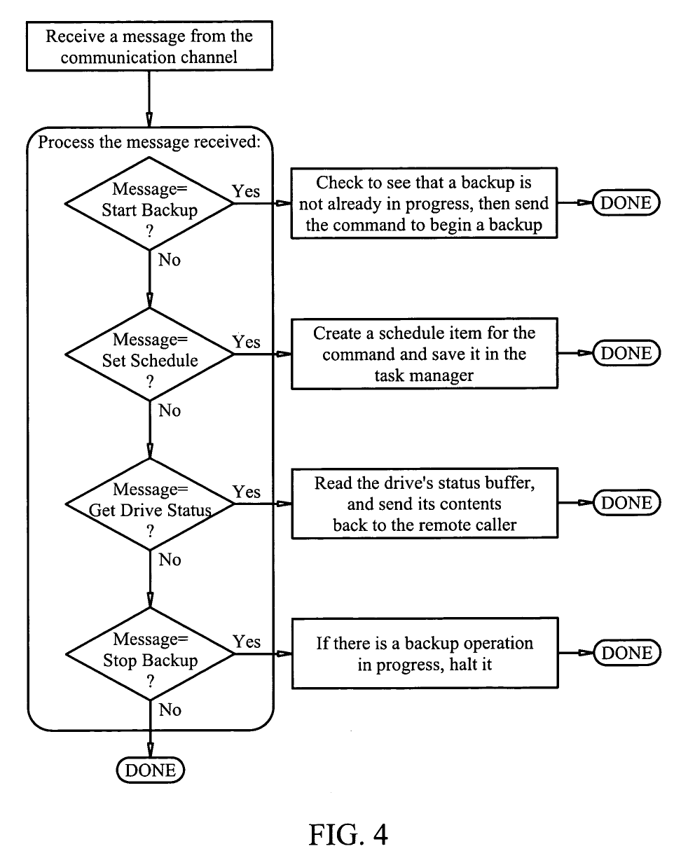

Referring now to FIG. 4, there is shown a flow chart of the software component of the novel interface. This component is in the form of executable instructions which will normally be running as a software control library installed on the host system where the hardware component of the intermediate device is also installed.

The exemplary flowchart lists the events that take place from a point of view of the software component of the invention. This component takes the form of a control library installed on the host system where the hardware component of the invention is also installed. The host computer system receives a message through a communication channel (usually, the network connection), and passes it on to the control library to be processed. The control library checks to see if it has an action defined for the command encapsulated in the incoming message. If so, it performs this action. If the message were a ‘Start Backup’ command, the control library would check the intermediate device to see if there was a backup in progress, and. if not, the software would send the device a command to start the backup. If the message were a ‘Set Schedule’ command, the control library would create a scheduled item for the command specified in the message. This item instructs the task manager on the host machine to execute the command at a given later time.

Invention also accepts a set of commands through which the remote administrator can gather information concerning the backup process. For example, if the message were a ‘Get Device Status’ command, the software would send the command to the intermediate device, causing the device to write its current status to a buffer. The software then accesses this buffer and sends the contents back to the remote process that sent the message. Examples of such information are drive make, models and serial numbers, last backup and restore times, problems reported during backup, and diagnostics of the system disk(s). There can also be provided a warning if there is insufficient storage space on the backup disk(s).

This Invention provides the unique advantage of allowing remote management of the backup operation, without the need for data to leave the user's local computer. The backup operations in no way effect the user, who may not even be aware that it is taking place. The user may also be able to override remote commands, if the system is so configured.

An exemplary business model for remotely managed local backup service would be configured as follows: A maintenance contract would detail a type of service to be performed by the remote operator. For instance, the service contract could specify periodic backup operations (e.g., daily) and diagnostic checks (e.g., weekly) to be performed on the customer's computer system. The local computer system, which may be a single computer or a multitude of individual computers connected in a local area network LAN, is enabled to receive the various commands concerning the backup operations, restore operations, diagnostics, and the like. The local computer, or each local computer, has an intermediate device and at least two hard drive disks connected to the intermediate device. The remote computer transmits the triggering command to the local computer(s) in accordance with the scheduled service. The local host computer, upon having performed the commanded process, transmits a confirmation message back to the remote computer that the process has been affected. In the alternative, the confirmation may also be had as an initial query upon the next command transmission from the remote computer.

I claim:

1. A computer system, comprising:
a host computer generating data output;
an intermediate device connected to receive the data output from said processor and configured to transfer the data to a plurality of channels; and
a plurality of data storage devices each connected to said hard disk drive controller for transferring data to or from a respective channel;
wherein a transfer of data between said data storage devices and through said intermediate device is effected substantially while said host computer remains enabled to transfer the data to and from at least one of said data storage devices.

2. The computer system according to claim 1, wherein the host computer is configured to receive remote commands via a network and send appropriate commands to said intermediate via the data cable or via a dedicated control port, local to said host computer.

3. The computer system according to claim 2, wherein said intermediate device is configured to perform a background image or file backup as requested by the remote command or set by schedule.

4. The computer system according to claim 1, wherein said intermediate device is configured to perform a background image or file restore from one of said data storage devices as selected by a user of the host computer.

5. The computer system according to claim 1, wherein said intermediate device is configured to receive a backup schedule for effecting an automatic backup even if a connection between said remote computer and said host computer is lost.

6. The computer system according to claim 1, wherein said intermediate device is configured to collect diagnostic data and to send the diagnostic data to said remote computer upon request.

7. A remote management method for local data backup, the method which comprises:
providing a local host computer having a main data storage device and a backup data storage device;
connecting the local host computer to a network and instructing the local host computer, substantially without involvement of an operator at said local host computer, to copy data from the main data storage device to the backup storage device or from the backup storage device to the main data storage device.

8. The method according to claim 7, which comprises managing a backup operation or a restore operation between the main data storage device and the backup storage device with a command from a remote computer system.

9. The method according to claim 7, which comprises managing a backup operation or a restore operation between the main data storage device and the backup storage device by sending a command from a remote computer system through the network, holding the command in abeyance in the local host computer, and processing the backup operation or the restore operation from the host computer at a later time.

10. The method according to claim 7, which comprises establishing a dedicated control port at the host computer, and performing remote backup management operations through the dedicated control port.

11. The method according to claim 7, which comprises performing remote backup management operation through a communications port of the host computer.

12. The method according to claim 7, wherein the remote computer instructs the local host computer to initialize a given schedule, and the local host computer is configured to perform maintenance operations in accordance with the given schedule substantially without further involvement of the remote computer.

13. A method of managing local computer backup operations in a system in which a local host computer with a main data storage device and a backup data storage device is connected to a remote computer via a network, the method which comprises:
under control of the remote computer:
issuing a maintenance command according to a predetermined schedule and transmitting the maintenance command through the network to the local host computer;
under control of the local host computer:
receiving and processing the maintenance command with the local host computer;
automatically performing a commanded maintenance operation by transferring data between the main data storage device and the backup data storage device substantially without involvement of a user of the local host computer and substantially without taking control of an operating system of the local computer away from the user of the local host computer; and
preparing the local host computer for further maintenance commands to be received from the remote computer.

14. The method according to claim 13, wherein the maintenance command is a backup command, a restore command, a diagnostic command, or a combination thereof.
